(19) United States
(12) Patent Application Publication
(10) Pub. No.: US 2015/0326075 A1
(43) Pub. Date: Nov. 12, 2015

(54) Fuel Pump

(71) Applicant: CONTINENTAL AUTOMOTIVE GMBH, Hannover (DE)

(72) Inventors: Jens MISSUN, Baunatal (DE); Wolfgang WARNKE, Herleshausen (DE)

(21) Appl. No.: 14/652,752

(22) PCT Filed: Dec. 16, 2013
(86) PCT No.: PCT/EP2013/076695

§ 371 Date: Jun. 16, 2015

(30) Foreign Application Priority Data
Dec. 17, 2012 (DE) 10 2012 223 459.

(51) Int. Cl. H02K 1/22; F04D 25/06; H02K 7/04; F04D 29/26; H02K 1/02; F04D 13/06; F04D 29/18

(52) U.S. Cl. CPC H02K 1/22; F04D 13/06; F04D 25/06; F04D 29/18; F04D 29/26; H02K 1/02; H02K 7/04

(57) ABSTRACT

A fuel pump with an electric motor having a stator, a shaft, and a rotor arranged on the shaft. The rotor is a magnetic rotor, and an impeller is driven by the shaft, which impeller is rotatably mounted in a pump housing. The rotor is made from a laminated core on which a plastic-bonded magnetic material is sprayed. On at least one side, the laminated core has a greater axial length than the plastic-bonded magnetic material.

### CROSS REFERENCE TO RELATED APPLICATION

This is a U.S. national stage of application No. PCT/EP2013/076695, filed on Dec. 16, 2013. Priority is claimed on German Application No.: DE102012223459.4 filed Dec. 17, 2012, the content of which is incorporated here by reference.

### BACKGROUND OF THE INVENTION

1. Field of the Invention

The subject matter of the invention is a fuel pump having an electric motor with a stator, a shaft, a rotor which is arranged on the shaft. The rotor is a magnetic rotor and an impeller is driven by the shaft that is mounted rotatably in a pump housing.

2. Detailed Description of the Prior Art

Fuel pumps of this type are used in fuel containers of motor vehicles and are therefore known. By way of said fuel pumps, fuel is conveyed out of the fuel container via a forward feed line to an internal combustion engine of the motor vehicle. The rotor, which is configured as a magnetic rotor, can configure the magnetic material in different ways and can be connected to the shaft. It is known to mix magnetic material as small particles with plastic and to form it into a corresponding shape by injection molding. A disadvantage of a rotor made from plastic bonded magnetic material is fact that the shaft has to be machined in advance to produce a secure firm seat with the injection molded material. For a positively locking connection, corresponding structures in the form of knurls or the like are formed on the shaft. Subsequently, the rotor has to be balanced. To this end, material is removed in a targeted manner. The magnetic particles produced in the process are very disadvantageous on account of their accumulation and contamination, in particular in the case of automated production.

Furthermore, it is known to spray the magnetic material over an iron core which has previously been pressed onto a smooth shaft such that the magnetic material completely encloses the iron core. In addition to the problem of the magnetic particles which are produced during balancing, a further disadvantage lies in the fact that score marks, which reduce the bearing service life are produced during pressing of the iron core onto the shaft.

### SUMMARY OF THE INVENTION

One embodiment of the invention is therefore based on providing a fuel pump, the rotor of which can be produced safely and reliably in an automated manner.

According to one embodiment of the invention, the rotor is formed by a laminated core, onto which a plastic bonded magnetic material is injection molded. The laminated core has a greater axial length on at least one side than the plastic bonded magnetic material.

The use of a punch bundled laminated core makes it possible to press the latter onto the shaft without the bearing service life of the shaft being influenced. By way of the greater axial length of the laminated core with respect to the magnetic material, it is possible to perform the balancing on the laminated core, as a result of which the production of magnetic particles that influence the production process is avoided. Automated production is simplified as a result.

A sufficient length for the balancing regions, without increasing the overall length of the fuel pump excessively, is achieved if the greater axial length of the laminated core on the at least one side is at most 2 cm, preferably from 0.5 cm to 1 cm.

In a further refinement, the plastic is polyPhenylene sulfide (PPS). PPS makes a homogeneous distribution of the, magnetic material in the plastic possible and can be injection molded satisfactorily.

Satisfactory processability in the injection molding process and satisfactory magnetic properties are achieved according to further advantageous refinements with the use of neodymium iron boron, ferrite powder or a hybrid material of neodymium iron boron/ferrite as magnetic materials.

Moreover, the design of the fuel pump is particularly favorable if the material that remains during the production of the laminated core of the stator is used for the production of the laminated core of the rotor.

### BRIEF DESCRIPTION OF THE DRAWINGS

The invention will be described in greater detail using one exemplary embodiment. In the drawing:

FIG. 1 is a fuel pump in a diagrammatic illustration; and

FIG. 2 is a section the rotor according to FIG. 1.

### DETAILED DESCRIPTION OF THE PRESENTLY PREFERRED EMBODIMENTS

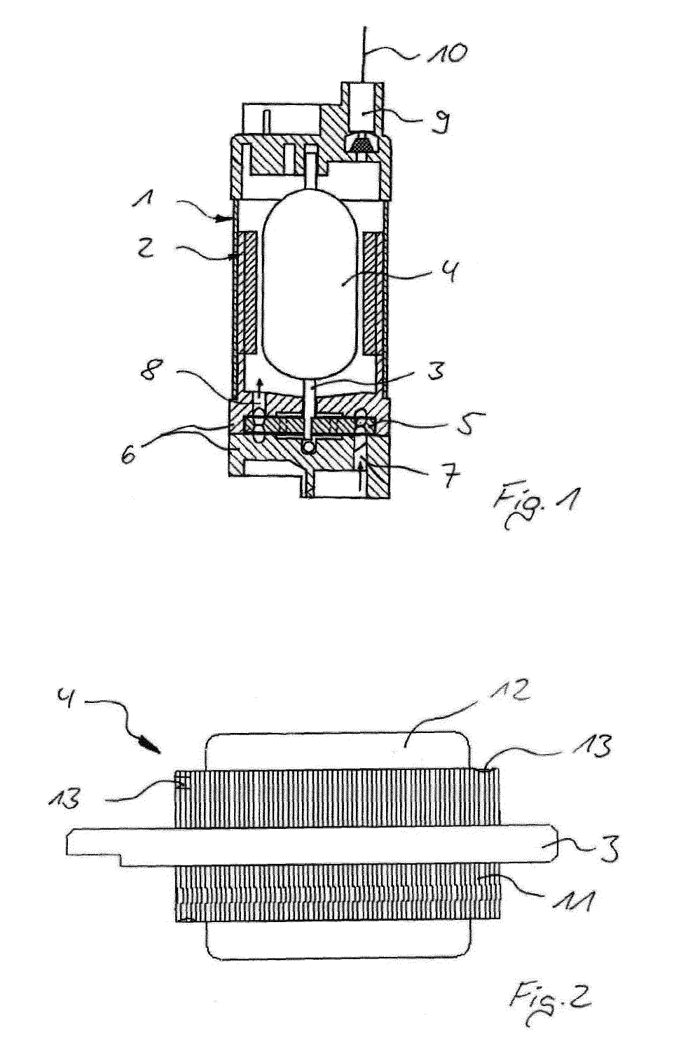

FIG. 1 shows a fuel pump having an electric motor 1, with a stator 2, a shaft 3, a rotor 4 arranged on the shaft 3, the rotor 4 being configured as a magnetic rotor, and an impeller 5 driven by the shaft 3 and is mounted rotatably in a pump housing 6. Upon rotation of the impeller 5, fuel is drawn from a fuel container via a pump inlet 7 and is conveyed via a pump outlet 8 in the pump housing 6, through the electric motor 1 to an outlet 9 of the fuel pump. From there, the fuel passes via a forward feed line 10 to the internal combustion engine (not shown) of the motor vehicle.

The rotor 4 in FIG. 2 includes the shaft 3, onto which a laminated core 11 is pressed. Polyphenylene sulfide with neodymium iron boron material as plastic bonded magnetic material is injection molded onto a part of the laminated core 11, approximately 1 cm is not covered by the magnetic material 12 on each side of the laminated core 11. Said non-covered regions are the balancing regions 13, in which the rotor 4 is balanced by way of material removal from the laminated core 11.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A fuel pump comprising:
a stator;
a shaft;
an impeller mounted rotatably in a pump housing and driven by the shaft; and
a magnetic rotor arranged on the shaft, the magnetic rotor comprising:
a laminated core;
a plastic bonded magnetic material injection molded onto the laminated core,
wherein the laminated core has a greater axial length on at least one side than the plastic bonded magnetic material.

7. The fuel pump as claimed in claim 6, wherein at least one balancing region is arranged on a projecting part of the laminated core where the laminated core extends beyond the plastic bonded magnetic material.

8. The fuel pump as claimed in claim 6, wherein the greater axial length of the laminated core on the at least one side is at most 2 cm.

9. The fuel pump as claimed in claim 6, wherein a plastic of the plastic bonded magnetic material comprises polyphenylene sulfide (PPS).

10. The fuel pump as claimed in claim 6, wherein a magnetic material of the plastic bonded magnetic material is at least one of neodymium iron boron and a ferrite.

11. The fuel pump as claimed in claim 8, wherein the greater axial length of the laminated core on the at least one side is 0.5 cm to 1 cm.
